(19) United States
(12) Patent Application Publication
(10) Pub. No.: US 2010/0290171 A1
(43) Pub. Date: Nov. 18, 2010

(54) METHOD AND DEVICE FOR PRODUCING A BIPOLAR IONIC ATMOSPHERE USING A DIELECTRIC BARRIER DISCHARGE

(75) Inventors: Markus Wild, Karlsruhe (DE); Gerhard Kasper, Karlsruhe (DE)

Correspondence Address: LERNER GREENBERG STEMER LLP, P O BOX 2480, HOLLYWOOD, FL, 33022-2480, US

(73) Assignee: GIP MESSINSTRUMENTE GMBH, Muldestausee (DE)

(21) Appl. No.: 12/781,359

(22) Filed: May 17, 2010

(30) Foreign Application Priority Data
May 16, 2009 (DE) 10 2009 021 631.6

(51) Int. Cl. H01T 23/00

(52) U.S. Cl. 361/231

(57) ABSTRACT

A method produces a bipolar ionic atmosphere using a dielectric barrier discharge, and to a device suitable for carrying out the method. The solution for achieving this aim is to trigger an electrical surface discharge at more or less regular intervals on the wall of a channel through which a gaseous medium flows. The flow channel is formed by a dielectric and a wall electrode such that the channel wall consists in the direction of flow alternately of a conductive electrode material and a dielectric. In principle it will suffice if the channel is formed of only one dielectric and one conductive section which adjoin each other. The electrical surface discharge is triggered by a second electrode which is separated by the dielectric from the wall electrode and the flow channel, and to which a temporally varying high voltage is applied by an impulse generator.

### CROSS-REFERENCE TO RELATED APPLICATION

This application claims the priority, under 35 U.S.C. §119, of German application DE 10 2009 021 631.6, filed May 16, 2009; the prior application is herewith incorporated by reference in its entirety.

### BACKGROUND OF THE INVENTION

### Field of the Invention

The invention relates to a method for producing a bipolar ionic atmosphere using a dielectric barrier discharge, especially for the neutralization of gas-born particles, or for producing a defined ionic atmosphere for ion mobility spectrometry, and to a device suitable for carrying out the method.

Particles become charged by interactions with their surroundings. The electrical charges are, as a rule, not desired and must be neutralized. However, the electrically charged fluid droplets contained in a gas stream or dust particles (aerosols) can be handled only with difficulty. A dust explosion can even occur because of charge deposition and consecutive spark formation. Moreover, when using aerosols in industry or in metrological characterization of aerosols (for environmental protection, for example), comparable and reproducible results can be obtained only with uniform and defined charge states of the particles (Boltzmann charge distribution).

For the reasons given above methods and devices were developed for neutralizing the electrical charge of the particles, i.e. to reduce the existing net charge as far as possible.

Neutralizing agents are used for this purpose which produce in the gas space surrounding the particles a sufficient number of gas ions of both polarities (ion pairs) per time unit which subsequently effect a charge equalization by attachment to the corresponding particle surfaces, thereby reducing or eliminating the surface charge. The provision of positive and negative ions of the same concentration makes possible neutralization both of the positive and negative charge state.

In the known methods for neutralizing aerosols, gas ions are produced by ionizing radiation or electrical discharge.

When radioactive substances are used as an ion source, the radioactive decay leads to the emission of energy quanta which produce a relatively balanced bipolar ionic atmosphere in the surrounding gas space by the ionization of neutral molecules. This type of neutralizing agent has a practical application in the field of particle measurement technology for example. However, the strict safety-related regulations relating to handling radioactive material present a disadvantage here.

Because of the prescribed measures relating to radiation protection, the use is restricted to radioactive sources with very small intensities. Such devices have only a small neutralizing performance.

With neutralizing agents working on the basis of corona discharge, the use of two discharge systems with opposed polarities is necessary and their ion clouds must be produced and mixed in exactly the same ratio in order to produce a neutralizing effect. A complex control technique is necessary to do this. Moreover, the devices are sensitive to changes in the particle loading and the composition of the gas phase and are therefore susceptible to faults.

There is also a special form of corona-based neutralizing agents which manages with just one discharge system, triggering discharges of alternating polarities using an AC voltage. The method and a device for charging and charge reversing aerosols in a defined charge state of a bipolar diffusion charging using an electrical discharge in the aerosol space is described in published, non-prosecuted German patent application DE 103 48 217 A1, corresponding to U.S. Pat. No. 7,031,133.

A method is also known from German patent DE 10 2007 042 436 B3 for charging, charge reversing or discharging ions, especially for charging and charge reversing aerosol particles. The ions are produced outside a neutralization region in an ion production region. The ions are transported convectively to the neutralization region by an oscillating flow.

Ion mobility spectrometry is a measuring method for detecting foreign substances of a low concentration in the ambient air or in gases. An ion mobility spectrometer, such as the type used on time of flight types, contains a reaction chamber in which the substances to be analyzed are partially ionized, and a drift chamber in which the ions produced are separated in a drift gas according to their mobility. The two chambers are separated by an electrical switching gate. Currently, it is mainly radioactive materials that are used for the primary ionization of gas molecules in the reaction chamber. The ionization can also be effected by corona discharge.

A major disadvantage of corona-based systems is that high electrical field strengths are required for maintaining the gas discharge which can lead to an undesired precipitation of the particles to be neutralized. This disadvantage can be overcome by a spatial separation of the ion production from the charging volume, though a large part of the ions are lost before their entry into the particle charging region by recombination or by losses through the walls. Accordingly, more ions and thus more ozone must be produced than is required for neutralization, or the performance of the neutralizing agent is correspondingly reduced. Furthermore, a flushing gas flow is required for transporting the ions from the corona zone into the charging space which leads to an unwanted dilution of the aerosol.

### SUMMARY OF THE INVENTION

It is accordingly an object of the invention to provide a method and a device for producing a bipolar ionic atmosphere using a dielectric barrier discharge which overcome the above-mentioned disadvantages of the prior art methods and devices of this general type, which is economical to operate and avoids the disadvantages of known methods.

With the foregoing and other objects in view there is provided, in accordance with the invention a method for producing a bipolar ionic atmosphere using a dielectric barrier discharge, for neutralizing gas-born particles or for producing a defined ionic atmosphere for ion mobility spectrometry. The method includes triggering an electrical surface discharge on a wall of a channel, through which a gaseous medium flows, by applying a temporally variable high voltage to an excitation electrode, so that ions of both polarities are produced in the gaseous medium flowing through the channel in approximately equal concentration under almost zero-field conditions. The channel is formed of at least one section formed as a dielectric and one electrically conductive section functioning as an initial electrode. The excitation electrode is separated by the dielectric from the initial electrode and the channel.

According to the proposed method an electrical surface discharge is triggered at more or less regular temporal intervals on the wall of a channel through which a gaseous medium flows. The flow channel is formed by a dielectric and at least one electrode (the wall electrode) in such a way that the channel wall in the direction of flow is formed alternately of dielectric and conductive electrode material. It will suffice in principle if the channel is formed of only one dielectric and one conductive section adjoining each other. The electrical surface discharge is triggered by at least a second electrode (the excitation electrode) to which a varying high voltage is applied, with the electrode separated by the dielectric from the wall electrode and the flow channel. The precise form of the high voltage pulses or their application at precise temporal intervals is not critical. Ions of both polarities, which can be used for different applications, are produced by the surface discharge at approximately the same concentration under zero-field conditions in the gas flowing through the channel. Preferred applications are the neutralization of gas-born particles or the production of a defined ionic atmosphere for ion mobility spectrometry.

The suggested method can be used for neutralizing extensive charged surfaces, such as in the field of electrophotographic reproduction, or for the coating of substrates. A further application is the use for plasma chemistry, whether in the gaseous phase or on the aerosol.

It is vital that the flow channel is largely free from radial electrical fields to enable a bipolar ionic atmosphere to exist in the flow channel. This condition is achieved according to the laws of electrostatics by surrounding a large part of the flow channel by electrically conductive surfaces (the wall electrode). Field simulations have shown that the radial electrical field in the electrode region in the typical embodiments of the inventions is in fact negligible.

A high-voltage pulse generator is used as a power supply for the excitation electrode. The pulses required for forming and maintaining the plasma can be of any form, with triangular, sine, rectangular or spike pulses being suitable in principle. The pulse sequence can be periodic or random. It is a prerequisite, however, that the pulses are sufficiently frequent and sufficiently intensive to ensure a continuous supply of ions to the gas stream. The pulse sequence-frequency lies, for example, between 100 and 5,000 Hz, and the pulse voltage between 2,000 and 10,000 volts.

The number of pulses can be controlled dependent on the gas volume stream in such a way that the gas stream is continually supplied with sufficient ions.

The method proposed is suitable preferably for neutralizing gas-born particles (aerosols) of any sort. That includes liquids in the form of drops down to the nanometer size range.

According to one preferred embodiment, the gas-born particle stream (aerosol) is conducted through the flow channel, with the bipolar ions attaching to the aerosol particles and neutralizing them. This embodiment variant has the advantage that a neutralizing agent working according to this principle can be directly integrated into a line conducting the aerosol stream, without any further dilution taking place. The production of the ions and the electrical charge reversing of the particles contained in the aerosol stream therefore take place in one space, in the flow channel. An alternative possibility is to arrange that only gas flows through the flow channel in which the surface discharging takes place. The gas stream containing the ions of both polarities can subsequently be conducted into a separate space for neutralizing an aerosol or another surface.

In other respects, the method proposed can be operated under the same conditions as for commercially available neutralizing agents.

The following parameters are given in this connection by way of example.

Pressure: 100 mbar to 5 bar (it is difficult to maintain the discharge above this range); the operating temperature is heavily dependent on the dielectric (PTFE<200° C.; ceramics significantly higher); air humidity: <90%; aerosol concentration: 10⁸ cm⁻³ or higher (therefore at least as high as normal devices).

Compared with the known methods of neutralizing particles using ionizing radiation or corona discharge, the method proposed makes possible a reliable and safe handling and improved performance. Moreover, the device-related expenditure for implementing this method is relatively small. Very good neutralizing results were achieved in laboratory tests.

A suitable device for carrying out the method has a flow channel whose channel wall contains in the direction of flow alternately at least one electrically conductive section as the initial electrode (wall electrode) and a section formed as a dielectric. The sections of the wall electrode and the dielectric are adjoining. A surface discharge is produced between the wall electrode and the dielectric by a second electrode (excitation electrode) which is separated from the initial electrode and the flow channel.

This removes the necessity for a second electrode in the gas space so that an almost zero-free space is formed in the flow channel in the region of the discharge. The excitation electrode is connected to a high-voltage pulse generator.

The flow channel, formed of one or more wall electrode segments and one or more dielectric segments, is preferably formed as a cylindrical tube with a uniform internal diameter. The internal diameters of electrodes and dielectric can also vary, and have corresponding transition regions (e.g. bevellings, steps). The inner channel of the electrode can also be formed with a different cross-sectional shape, e.g. as a slot or elongated hole. Both series and parallel arrangements of the flow channels are possible.

The flow channel preferably is formed of two earthed wall electrode segments lying on a common axis and separated by one segment of dielectric. The flow channel is more effectively electrically shielded by the additional electrode, thereby improving the zero field conditions. In addition, the earthed embodiment leads to a reduction in particle losses in the flow channel.

The excitation electrode is either embedded as a ring-shaped electrode in the dielectric or attached to the outer wall of the dielectrics. It can be formed as a solid ring with a round or rectangular cross section or formed from a wire-shaped material. The dielectric can also be constructed in such a way that it can be separated into two parts with the excitation electrode then being arranged between those two parts.

When being used as a neutralizing agent, the device is inserted into a housing to facilitate handling. The device has corresponding connection nozzles for installation into an aerosol stream line.

The device according to the invention is of very compact construction and can be manufactured inexpensively. For example, an embodiment as a neutralizing agent has an overall length of only approximately 5 cm and, unlike corona-based neutralizing agents, can be operated without an additional control system.

Other features which are considered as characteristic for the invention are set forth in the appended claims.

Although the invention is illustrated and described herein as embodied in a method and a device for producing a bipolar ionic atmosphere using a dielectric barrier discharge, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 a diagrammatic, longitudinal sectional view of an initial embodiment of a device according to the invention;

FIG. 2 is a section view taken along the line II-II shown in FIG. 1;

FIG. 3 is a diagrammatic, longitudinal sectional view of a second embodiment of the device according to the invention; and

FIG. 4 is a diagrammatic, longitudinal sectional view of a third initial embodiment of the device according to the invention.

### DESCRIPTION OF THE INVENTION

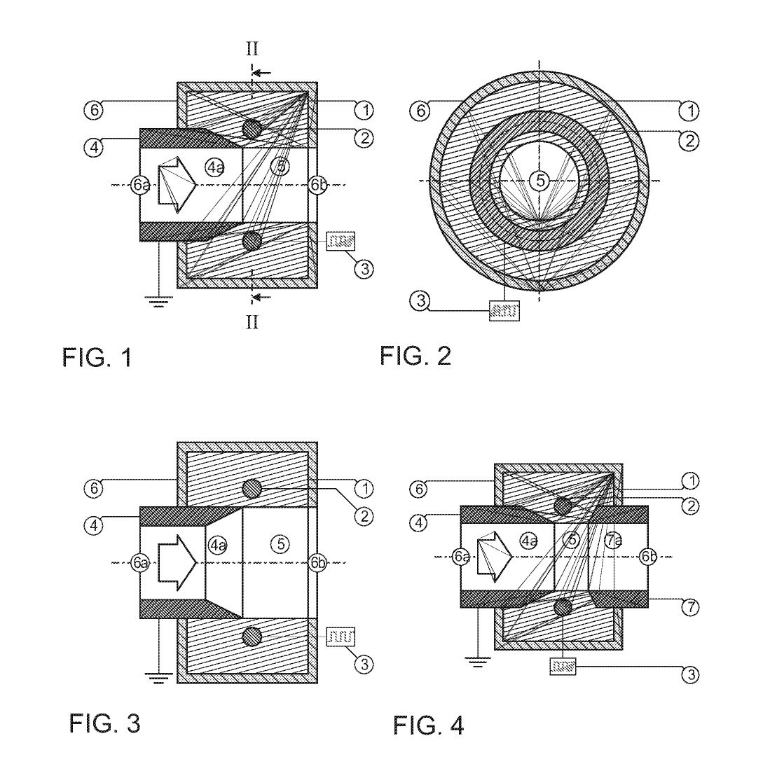

Referring now to the figures of the drawing in detail and first, particularly, to FIGS. 1 and 2 thereof, there is shown a device that is formed of a tubular dielectric 1, an excitation electrode 2, connected to a high-voltage pulse generator 3 and an earthed wall electrode 4, which is of tubular construction. The excitation electrode 2 is formed of a metallic wire material, which is cast with conductive epoxy resin, and formed as a ring which is placed round the tubular dielectric 1. The ring-shaped electrode 2 and the wall electrode 4 through whose interior a gaseous medium flows are arranged coaxially with respect to each other. The dielectric 1 is made of PTFE (polytetrafluoroethylene). Any other materials suitable for this purpose, e.g. ceramic or glass, can be used as a dielectric. The earthed wall electrode 4 has a central channel 4a and is inserted into the PTFE tube 1. The wall electrode 4 is beveled on the side pointing in the direction of the ring-shaped electrode 2. A flow channel 5 of the dielectric has a cylindrical shape because of the beveling on the wall electrode 4.

The beveling formed as a transition region can also be formed in the opposite direction inwards to outwards, as shown in FIG. 3. Otherwise, the structure of the device shown in FIG. 3 is the same as that shown in FIGS. 1 and 2.

The dielectric 1 with the ring-shaped electrode 2 and the wall electrode 4 are arranged in a housing 6 which has an inlet 6a and an outlet 6b.

The housing 6 is made of conductive material. It has an inner cylindrical shape and has a rectangular outer shape to facilitate handling. Moreover, the shielding effect leads to an improvement in electromagnetic compatibility. When the device is used for neutralizing aerosols, it is integrated via the connections 6a and 6b into a feeder line by which the aerosol is fed to a particle analyzer. The aerosol flows at a preset speed through the central flow channel 4a, 5 of the neutralizing agent in the direction indicated by an arrow. A pulsating high voltage is applied to the excitation electrode 2 for neutralizing or charge reversing the particles contained in the aerosol. The ring-shaped electrode 2 and the wall electrode 4 are separated by the solid dielectric 1, the PTFE tube. A plasma is formed on the inner side of the PTFE tube 1 by applying a pulsating high voltage. An electrical discharge is formed in the zone between the wall electrode 4, the dielectric 1 and the adjoining gas space by temporally variable high-voltage pulses, whereby positively and negatively charged ions are produced at approximately the same concentration simultaneously. Because of the special geometry of the earthed wall electrode 4, which is formed as a channel through which a gaseous medium flows, a zero-field space is formed in the region of the discharge. It is only in this way that the inherently bipolar character of the plasma is maintained.

Excitation signals of different forms can be used provided there is sufficient amplitude and edge steepness. The aerosol streams through the central channel sections 4a and 5. In this process the positively and negatively charged gas ions come into contact by diffusion with the surface of the particles contained in the aerosol, resulting in the establishment of a charge balance.

When the method is used for neutralizing, the neutralizing performance can be adjusted if necessary via the parameters of operating voltage and frequency.

The operating parameters of the neutralizing agents to be used depend on the geometry of the electrode. The wall thickness of the PTFE tube with a prototype used in testing was approximately 0.3 to 0.5 mm and the wall electrode 4 had an internal diameter of 4 mm and an external diameter of 6 mm. The overall length of the neutralizing agent is approximately 5 cm including the wall electrodes 4, 7 used as connections 6a, 6b.

The electrical discharge took place under the now described conditions.

Potential 5 to 8 kV (positive and negative), pulse form: rectangular signals, duty cycle 1:1 to 1:50, frequencies 100 to 5000 Hz.

The tests were carried out with aerosol volume flows of up to 10 l/min.

The size of the aerosol particles was in the range of 40 to 200 nm. After their discharge from the neutralizing agent, the particles were electrically neutral within the measuring accuracy of ˜0.1 elementary charges.

The embodiment shown in FIG. 4 differs from the embodiment shown in FIGS. 1 and 2 only to the extent that a second wall electrode 7 is positioned to improve shielding, the electrode having a cylindrical channel 7a over which the neutralized aerosol flows off. The beveling of the two wall electrodes 4 and 7 has different angles of inclination.

1. A method for producing a bipolar ionic atmosphere using a dielectric barrier discharge, for one of neutralizing gas-born particles and for producing a defined ionic atmosphere for ion mobility spectrometry, which comprises the step of:
triggering an electrical surface discharge on a wall of a channel, through which a gaseous medium flows, by applying a temporally variable high voltage to an excitation electrode, so that ions of both polarities are produced in the gaseous medium flowing through the channel in approximately equal concentration under almost zero-field conditions, with the channel formed of at least one section formed as a dielectric and one electrically conductive section functioning as an initial electrode, and at least the excitation electrode being separated by the dielectric from the initial electrode and the channel.

2. The method according to claim 1, which further comprises applying voltage pulses selected from the group consisting of triangular pulses, sine pulses, rectangular pulses and spike pulses to the excitation electrode.

3. The method according to claim 1, which further comprises forming a pulse sequence of the voltage pulses as one of periodic and random.

4. The method according to claim 1, which further comprises controlling a number of pulses in dependence on a gas volume flow such that a stream of the gaseous medium is continuously supplied with sufficient ions.

5. The method according to claim 1, wherein a constant change of polarity with a pulse sequence frequency of 100 up to 5,000 Hz takes place to maintain plasma.

6. The method according to claim 1, which further comprises producing bipolar ions and electrical reverse charging takes place in the channel for electrical neutralization of gas-born particles.

7. The method according to claim 1, which further comprises conducting a gaseous medium flow through the channel to neutralize gas-born particles and the gaseous medium flow containing bipolar ions into a separate space for electrical charge reversing of gas-born particles after the ions have been produced.

8. A device, comprising:
a flow channel having a channel wall in a direction of flow, said channel wall being formed alternately from at least one electrically conductive section functioning as a wall electrode and one section formed as a dielectric which adjoin each other; and
an excitation electrode which is separated by said dielectric from said wall electrode and said flow channel, said excitation electrode being connected to a high-voltage pulse generator.

9. The device according to claim 8, wherein:
said at least one electrically conductive section functioning as said wall electrode is formed from several sections;
said dielectric is formed from several dielectric sections; and
said at least one electrically conductive section and said dielectric are formed as a cylindrical tube.

10. The device according to claim 9, wherein said cylindrical tube formed from said wall electrode and said dielectric has a uniform internal diameter.

11. The device according to claim 8, wherein said wall electrode and said dielectric have different internal diameters.

12. The device according to claim 8, wherein said channel wall has transition regions between said wall electrode and said dielectric.

13. The device according to claim 8, wherein said flow channel has a cross sectional shape in a form of one of a slot and an elongated hole.

14. The device according to claim 8, wherein said flow channel has two earthed segments forming said wall electrodes and which lie on a common axis and are separated by said dielectric.

15. The device according to claim 8, wherein said excitation electrode is embedded as a ring-shaped electrode in one of said dielectric and attached to an outer wall of said dielectric.

16. The device according to claim 8, wherein said excitation electrode is formed as a solid ring with one of a round cross section and a rectangular cross section.

17. The device according to claim 8, wherein said dielectric is constructed such that said dielectric can be separated into two parts and said excitation electrode is disposed between said two parts.

18. The device according to claim 8, wherein said device is integrated into a line carrying a gas stream.
